(19) United States
(12) Patent Application Publication
(10) Pub. No.: US 2004/0258345 A1
(43) Pub. Date: Dec. 23, 2004

(54) Coupling to waveguides that are embedded in printed circuit boards

(76) Inventors: Elmar Griese, Olpe (DE); Andreas Himmler, Paderborn (DE); Jorg-Reinhardt Kropp, Berlin (DE); Lutz Melchior, Berlin (DE); Andreas Neyer, Iserlohn (DE); Walter Sullau, Uetze (DE)

Correspondence Address: MORRISON & FOERSTER LLP, 1650 TYSONS BOULEVARD, SUITE 300, MCLEAN, VA, 22102, US

(21) Appl. No.: 10/493,389

(22) PCT Filed: Jul. 8, 2002
(86) PCT No.: PCT/DE02/02507

(30) Foreign Application Priority Data
Jul. 6, 2001 (DE) 101 32 794.3

(51) Int. Cl. G02B 6/12

(52) U.S. Cl. 385/14; 385/52

(57) ABSTRACT

According to the invention, waveguides are contained in an optical layer of a printed circuit board. Said waveguides are produced by an embossing process and emit light in a perpendicular manner by means of oblique, reflective ends. Mechanical guide marks are created using the embossing process for positioning couplers, said marks being preferably used as guide holes for MT pins.

### CLAIM FOR PRIORITY

This application claims priority to International Application No. PCT/DE02/02507, which was published in the German language on Jan. 16, 2003, which claims the benefit of priority to German Application No. 101 32 794.3, which was filed in the German language on Jul. 6, 2001.

### TECHNICAL FIELD OF THE INVENTION

The invention relates to the coupling to waveguides that are embedded in printed circuit boards.

### BACKGROUND OF THE INVENTION

Printed circuit boards that contain not only electrical conductors but also optical waveguides are envisaged for future information and communication equipment. The article “New Technology for Electrical/Optical Systems on Module and Board Level: the EOCB Approach” by D. Krabe, F. Ebling, N. Arndt-Staufenbiel, G. Lang and W. Scheel, Proc. 50th Electronic Components & Technology Conference 2000, pp. 970-4 (ISBN 0-7803-5908-9), provides an overview of this.

A central task in this technology is the coupling of the components with optical transmitters and receivers to the optical waveguides, which, as a result of the small dimensions of the optical fibers, requires an accuracy of the positioning that cannot be accomplished with the conventional automatic placement machines. In particular, in the case of optical connections there is not the correction of positioning errors that is brought about in the soldering technique of electrical connections by the surface tension of the solder.

A solution in which hollow bodies are incorporated parallel to the surface and determine the position of optical couplers on which guide pins are attached is described in laid-open patent application DE 19917554. The optical couplers bring about a conversion into electrical signals or deflect the light to a converter located on the surface. However, the embedding of the hollow bodies and the later milling out are still relatively complex operations.

### SUMMARY OF THE INVENTION

The present invention describes another solution, which is less complex. In this case, a printed circuit board includes in an optical layer optical waveguides which are produced by an embossing process and couple light in and out in a perpendicular manner by means of oblique reflective ends. Mechanical guide marks are created using the embossing process for positioning couplers, the marks being preferably used as guide holes for MT pins.

In this case, optical waveguides with ends which are provided with reflective surfaces at a 45° angle are used. These are described for example in the article “Monomode Polymer Waveguides with Integrated Mirrors” by R. Wiesmann, S. Kalveram, A. Neyer; Proc. 22nd Europ. Conf. on Optical Communications (ECOC 96), vol. 2 pp. 265-8, Oslo 1996 (ISBN 8242304181). Other angles are also possible to bring about radiation transversely to the optical layer.

### BRIEF DESCRIPTION OF THE DRAWINGS

The invention is described in detail below with reference to exemplary embodiments shown in the figures, in which:

FIG. 1 shows a cross section in the longitudinal direction of one of the optical waveguides.

FIG. 2 shows a plan view in the direction of the arrow A indicated in FIG. 1.

### DETAILED DESCRIPTION OF THE INVENTION

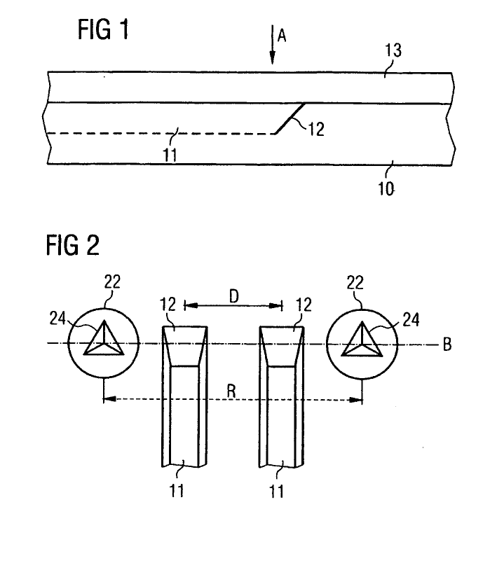

FIG. 1 shows a cross section in the longitudinal direction of one of the optical waveguides. Used in this case is a transparent carrier film 10, for example 200 μm thick, in which channels 11 for the waveguides are produced by means of an embossing process. Bevels for mirrors 12 are provided at the ends of the channels. The bevels are metallized. After that, the channels 11 are filled, the filling likewise being transparent of course and having a higher refractive index than the embossed material. After that, an again transparent film, with a smaller refractive index than the filling and a thickness of for example 100 μm, is applied as a covering layer 13, so that the filled channels 11 can serve as waveguides.

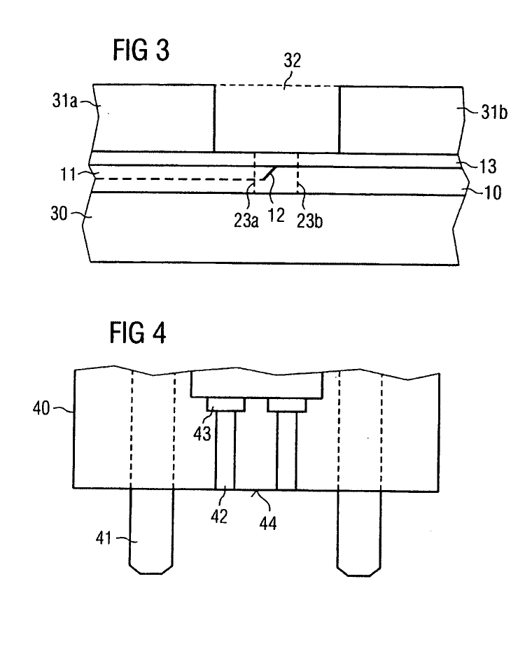

FIG. 2 shows a plan view in the direction of the arrow A indicated in FIG. 1. The channels 11 may be tapered downward, to avoid undercuts during the embossing. This effect is exaggerated in the representation. D denotes the grid spacing of the waveguides, which in the case of a width of the waveguides of 100 μm, i.e. an approximately square cross section, is for example 250 μm.

For the invention, in addition to the channels 11, which after filling make up the optical waveguides, reference marks 24 are also formed by the embossing near the ends 12 of the optical waveguides. Their position in relation to the ends 12 of the optical waveguides is determined by the high production accuracy of the embossing tool and can be produced with an accuracy which is significantly better than the diameter of an optical waveguide.

After applying the covering layer 13, these reference marks are used for making perpendicular holes 22 of predetermined diameter in the optical layer. Used with preference is the diameter of 0.7 mm of mechanical guide pins, which are known for example from MT plug-in connectors. Either the reference marks can be optically scanned, for example in the form of a cross and with a V-shaped cross section, in order to provide a center which is exact, can be optically detected well and positions a drill by means of an optical positioning system. Drilling can optionally be carried out from the direction of the covering layer, i.e. the upper side, or from the underside. Whether these reference marks are embossed or coated with the metallization used for the reflective finish depends on the properties of the drilling system. If a double-sided embossing tool is used, the reference mark may also be created from the underside of the carrier film 10 and then, formed for example as a cone, contribute to the guiding of the drill when drilling is carried out from below.

Once the guide holes 22 have been made in the optical layer, the latter can be incorporated in a printed circuit board by known methods. The result is shown in FIG. 2. The optical layer has been applied to a lower layer 30 and is covered by an upper layer 31a, 31b. Through a gap 32 in the upper side, referred to as an aperture, the optical layer is accessible at the reflective ends 12 of the optical waveguides. The aperture 32 is large enough for the guide holes 22, which are merely indicated in FIG. 3 by their walls 23a, 23b, also to be accessible.

The connection to the optical waveguides then takes place by couplers, which are inserted from above. FIG. 4 schematically shows the part of a coupler 40 that is to be inserted into the aperture 32. On the underside 44 there are guide pins 41 in the direction of insertion. Between them, waveguides 42 end. One end of the waveguides ends at the surface of the underside 44, the other in transmitting or receiving converters 43. These are then connected (not shown) via electrical connections to amplifier circuits and electrical contacts, which are generally formed as solder contacts.

The guide pins 41 of the couplers have the same spacing as the guide holes 22 in the optical layer. Normally, both the ends of the optical waveguides in the optical layer and the ends of the optical waveguides in the coupler lie symmetrically on the joining line of the guide holes 22 or guide pins 41 and have the same spacing in the optical layer and the coupler. This is achieved, for example, by trenches for both the optical waveguides and the guide pins being provided in a molded part. After the optical waveguides have been placed in, a second, usually identical, molded part is placed on and so this part of the coupler is closed—usually by adhesive bonding. After that, the area in which the optical waveguides emerge is polished, to reduce contact losses. Subsequently, the guide pins are inserted into the holes brought about by the trenches.

The hardness of the optical layer, which includes for example of polycarbonate, is sufficient to position the guide pins exactly to the fraction of a diameter of a waveguide. The surface of the underside 41 of the couplers lies flush on the covering film of the optical layer. The light from or to the coupler passes through this covering layer.

The guide pins preferably have a length protruding from the underside that corresponds to the thickness of the optical layer, that is in the example 0.3 mm. In this case, an aperture at the point of the guide holes in the lower layer 30 is not necessary. Alternatively, however, a relatively small aperture, of for example 2 mm in diameter, may be provided around each of the guide holes in the lower layer 30 (not shown in FIG. 3). In this case, the guide pins in the coupler are made significantly longer than the thickness of the optical layer and are preferably provided with a definite facet at the end or are conically formed.

A further possibility for producing the guide holes uses an automatic embosser, with which the guide holes, in particular cylindrical guide holes, are embossed through the entire material thickness. This operation is also referred to as “stamping”. The covering layer 13 is now not completely continuous, but is provided with holes, likewise by embossing or stamping, which are larger than the guide holes by at least as much as the positioning accuracy during the subsequent application of the covering layer. This is for example 0.1 mm, so that the holes in the covering layer have a diameter of 0.95 mm, in order to be certain to leave the stamped holes in the carrier film free. The guide pins on the couplers 40 are formed as previously and are in this case not guided over the first third, i.e. the thickness corresponding to the covering layer.

After the couplers have been inserted and engaged in the correct position, determined by the guide holes, they are definitively fastened by other means. These may be screw connections or adhesive bonds. In any event, they are designed such that the couplers do not slip on the optical layer as a result of the soldering of the electrical connections. For example, the aperture may be filled after the insertion of the coupler with a self-polymerizing optical adhesive, which at the same time penetrates into the transitional layer between the underside of the coupler and the upper side of the optical layer and consequently improves the coupling. Alternatively, an index-adapted gel may be used here and the cases presented further below.

Alternatively, the coupler may be connected to the printed circuit board by means of releasable contacts, the direction of insertion being perpendicular to the surface of the printed circuit board. The optical connections are aligned to match by the guide elements on the coupler or in the optical layer. Either the couplers are screwed, adhesively bonded or permanently fastened in some other way, as before. It is also possible, however, to bring about contact pressure in a direction perpendicular to the surface of the printed circuit board by a spring clip or other measures. This on the one hand fixes the guide elements in relation to one another. On the other hand, the releasable electrical contact connection can at the same time be secured in this way.

So far it has been described that MT guide pins that reach into guide holes in the optical layer are used in the coupler. However, it is also quite possible when producing the molded parts for the coupler 40 to create indentations or recesses on their underside 44, so that the use of separate MT pins is no longer needed. With a thickness of 100 μm of the covering layer and 200 μm of the optical layer, these formations would have to protrude by 300 μm or 0.3 mm. This is possible without any problem with known forming methods. Since they are produced by the same production step with which the trenches for the optical fibers 42 that lead from the surface to the electrooptical elements 43 are produced, the necessary high accuracy is achieved.

If protruding formations formed on in this way are used, the height can be controlled well. It is therefore not necessary to provide through-holes in the optical layer in this case either. Rather, it is adequate to stamp in the optical layer depressions which amount to ¾ of the layer thickness, that is for example 150 μm. The protruding formations would then have to protrude by 350 μm if the covering layer is 100 μm thick.

Instead of cylindrical holes and pins, it is also possible in this case to use other forms. These are in particular square recesses and protruding formations. A slightly trapezoidal form in cross section ensures that the edges grip well during the positioning. With appropriately chosen materials, a trench with a triangular cross section may also be advisable. Furthermore, two guide elements may be provided on each side, moving together in particular to give a cruciform formation with a rectangular, trapezoidal or triangular cross section of the limbs. In an extreme case, a structure in the form of a pyramid is created.

In this way, the protruding formation can also be readily provided on the optical layer and the recess in the coupler. The latter has the advantage that the polishing of the surface with the optically effective parts is significantly easier. For the optical layer it is possible to provide the mechanical guide elements both as protruding formations and as recesses. The latter are achieved by depressions in the embossing die.

1. An optical layer with optical waveguides, at ends of the optical waveguides coupling of optical signals is brought about by radiation transversely to a plane of the optical layer, wherein near the ends of the optical waveguides mechanical guide elements are provided on the optical layer, positions of which with respect to the ends of the optical waveguides are predetermined.

2. The optical layer as claimed in claim 1, the optical layer comprising a carrier film in which the position of the optical waveguides and the position of the guide contours are determined by in a same step of a production process.

3. The optical layer as claimed in claim 1, wherein the mechanical guide elements are prismatic or cylindrical openings, the walls of which determine the positions.

4. The optical layer as claimed in claim 4, wherein the guide elements are through-holes in the carrier film.

5. The optical layer as claimed in claim 1, wherein the mechanical guide elements are protruding formations.

6. The optical layer as claimed in claim 1, wherein the optical layer comprises a carrier film and a covering film, the guide elements being present in the carrier film and the covering film having recesses in the region of the guide elements.

7. The optical layer as claimed in claim 1, wherein the optical waveguides are reflective at their ends.

8. A printed circuit board with electrical and optical layers, the optical layer with optical waveguides, at ends of the optical waveguides coupling of optical signals is brought about by radiation transversely to a plane of the optical layer, wherein near the ends of the optical waveguides mechanical guide elements are provided on the optical layer, positions of which with respect to the ends of the optical waveguides are predetermined.

9. A production method for an optical layer for a printed circuit board with optical connections, comprising:
producing an optical layer by embossing channels for optical waveguides on a carrier film, filling the channels and laminating with a covering layer;and
forming mechanical guide elements by the embossing of certain positions.

10. The production method as claimed in claim 9, the guide elements created by position marks which are created by the embossing, such that a drilling tool creates guide openings.

11. The production method as claimed in claim 9, the guide elements passing through the carrier film created by the embossing and the covering layer having recesses for the guide elements.

12. A production method for a printed circuit board with optical connections, in which an optical layer is produced by producing an optical layer by embossing channels for optical waveguides on a carrier film, filling the channels and laminating with a covering layer, and forming mechanical guide elements by the embossing of certain positions, and the optical layer is embedded in a printed circuit board, an aperture being provided at least on one side, allowing access to ends of the optical waveguides and guide openings.

13. A coupling element for connection to optical waveguides included in a printed circuit board, wherein
the coupling element has a region with a planar coupling area, and
on the planar coupling area there are optically effective zones and mechanical guide elements, positions of which with respect to optically effective zones are predetermined.

14. The coupling element as claimed in claim 13, wherein the position of the mechanical guide elements and the position of the optically effective zones are determined by a same step of a production process.

15. The coupling element as claimed in claim 13, wherein cylindrical pins made to fit into recesses in the coupling elements are used the mechanical guide elements.
